(19) United States
(12) Patent Application Publication
(10) Pub. No.: US 2007/0252116 A1
(43) Pub. Date: Nov. 1, 2007

(54) Flame retardant composition

(75) Inventors: Mark Gelmont, (US); Michael Peled, (US); Dina Alon, (US); Ron Frim, (US)

Correspondence Address: NIXON & VANDERHYE, PC, 901 NORTH GLEBE ROAD, 11TH FLOOR, ARLINGTON, VA, 22203, US

(73) Assignee: Bromine Compounds Ltd., Be'er Sheva (IL)

(21) Appl. No.: 11/797,144

(22) Filed: May 1, 2007

(30) Foreign Application Priority Data
May 1, 2006 (IL) 175339

(51) Int. Cl. C09K 21/00

(52) U.S. Cl. 252/601

(57) ABSTRACT

A flame retardant composition which comprises a first liquid, which is selected from the group consisting of non-halogenated polyols and mixtures thereof; a second liquid, which is selected from the group consisting of halogenated polyols or mixtures thereof; and tetrabromobisphenol A.

4,4′-isopropylidene-bis(2,6-dibromophenol), which is also known as tetrabromobisphenol A (hereinafter sometimes abbreviated TBBA) is a flame retardant used in various polymeric compositions.

Tetrabromobisphenol A was proposed in the art for retarding the flammability of rigid foams based on isocyanate, in particular polyurethane and polyisocyanurate foams. However, at ambient temperature, tetrabromobisphenol A is not readily dissolved in the liquid mixture used for the preparation of the foams. In view of the fact that it is often required to prepare the polyurethane foam outdoors under time constrains, e.g., in construction sites, the process of homogeneously blending tetrabromobisphenol A in the liquid precursor of the polyurethane foam may constitute a significant difficulty.

WO 03/060000 describes a liquid flame retardant composition useful for the preparation of flame-retarded polyurethane foams, which comprises tetrabromobisphenol A, at least one liquid ester of a pentavalent acid of phosphorus and at least one additional organic halogen-containing reactive flame retardant, wherein as the latter component the diester/diol of tetrabromophthalic anhydride (SAYTEX RB-79, also known as PHT-4 diol) was specifically exemplified. Each of the compositions illustrated in the examples of WO 03/060000 appears to have a tetrabromobisphenol A concentration of 35-50% (w/w), a bromine content between 28% and 35% (w/w), and hydroxyl values in the range of from 22 to 55 mg KOH/g (the term hydroxyl value indicates the number of reactive hydroxyl groups available for reaction, and is expressed as the number of milligrams of potassium hydroxide equivalent to the hydroxyl content of one gram of the sample). It also appears that the hydroxyl functionality of each of the exemplified compositions is 2, since the only hydroxyl-containing material in the composition is the aforementioned PHT-4 diol.

JP 10-025413 describes flame retarded precursors for polyurethane which comprise tetrabromobisphenol A.

Another class of flame retardants used in the manufacture of rigid polyurethane foams is liquid aliphatic halogenated polyether-polyols. For example, U.S. Pat. No. 5,264,463 describes the use of Ixol B350 and Ixol B251 (the Ixols are halogenated aliphatic polyether-polyols containing chlorine and bromine) for preparing polyurethane foams.

It has now been found that it is possible to dissolve considerable quantities of tetrabromobisphenol A in a mixture comprising a first liquid, which is a non-halogenated polyol, and a second liquid, which is a halogenated polyol, to give a highly brominated liquid composition from which the precipitation of tetrabromobisphenol A is substantially prevented during long storage periods at ambient temperature.

Accordingly, the present invention provides a liquid flame retardant composition which comprises a first liquid, which is selected from the group consisting of non-halogenated polyols and mixtures thereof; a second liquid, which is selected from the group consisting of halogenated polyols and mixtures thereof; and tetrabromobisphenol A, wherein the weight ratio between said tetrabromobisphenol A and said first liquid is preferably not less than 2:3, and more preferably not less than 3:4, and most preferably not less than 1:1.

The bromine content of the composition provided by the present invention may vary within the range between 20 and 40%, and is preferably not less than 24% (w/w), and more preferably not less than 27% (w/w), and is most preferably not less than 30% (relative to the total weight of the composition).

The first liquid component in the composition of the invention is a non-halogenated polyol, the number of hydroxyl groups of which is preferably not less than 3, or a mixture of such polyols.

Suitable non-halogenated polyols to be used according to the present invention include polyether-polyols. This class of polyols is obtained by the ring opening addition reaction of one or more alkylene oxides (e.g., ethylene oxide and propylene oxide) with a suitable reactant containing active hydrogen atoms, such as alcohols, amines and acids; more specifically, said reactant may be selected from the group consisting of diols, triols, novolac resins, pentaerythritol, sorbitol, sucrose, ethylenediamine, diethylenetriamine and the like. Polyester-polyols may also be used according to the present invention; this class of polyols is obtained by the condensation reaction of dicarboxylic (or polycarboxylic) acid, such as adipic acid, phthalic acid or the like, with glycols (e.g., ethylene glycol, diethylene glycol, trimethylol propane and the like). A particularly preferred non-halogenated polyol to be used according to the present invention is a glycerol-based polyether-polyol. The hydroxyl number of the non-halogenated polyol is preferably in the range of 150 to 850 mg KOH/g, and more preferably in the range of from 200 to 600 mg KOH/g.

The weight concentration of the non-halogenated polyol(s) relative to the total weight of the composition is preferably between 10 and 50%, and more preferably between 20 and 40%.

The second liquid component in the composition of the invention is provided by one or more halogenated polyols, wherein the bromine and/or chlorine atoms thereof may be attached either to an aliphatic or an aromatic radical.

Suitable halogenated polyether-polyols that contain aliphatic bromine and/or aliphatic chlorine, which may be used as the second liquid of the composition according to the present invention, are described in U.S. Pat. No. 4,067,911, which is incorporated herein by reference. Preferred halogenated polyether-polyols are obtained by reacting a suitable unsaturated diol, such as 2-butyne-1,4-diol, with epichlorohydrin, dehydrochlorinating the resulting intermediate to give diglycidyl or polyglicydil ether of the epichlorohydrin oligomer, reacting the same with C₁-C₅ aliphatic alcohol, which is preferably methanol, and finally brominating an unsaturated functionality present therein, to give the halogenated polyether-polyols.

Halogenated polyether-polyols which contain aliphatic bromine are commercially available under the trade name Ixol®, e.g. Ixol B 350 (Solvay).

Halogenated polyether-polyols that contain aromatic bromine, which are suitable for use as the second liquid according to the present invention are obtainable by polymerizing a mixture of polyether polyol and brominated polyhydroxy aromatic compound with ethylene- or propylene oxide according to methods well known in the art. A commercially available example is VD-400 (Resina Chemie).

The weight concentration of the halogenated polyol(s) relative to the total weight of the composition is preferably in the range of 5 to 75%, and more preferably in the range of 10 to 50%, and most preferably in the range of 30 to 40%.

Tetrabromobisphenol A is a commercially available product. Methods for preparing tetrabromobisphenol A are described, for example, in U.S. Pat. No. 3,546,302, U.S. Pat. No. 3,929,907, U.S. Pat. No. 6,365,786, U.S. Pat. No. 5,475,153 and WO 96/33964, which are incorporated herein by reference. Preferably, high purity tetrabromobisphenol A is used according to the present invention. The preparation of tetrabromobisphenol A is generally based on the bromination of bisphenol A. Tetrabromobisphenol A which contains small amounts (typically up to 2.0 wt %) of underbrominated bisphenol A derivatives may also be used according to the present invention. The concentration of tetrabromobisphenol A in the composition is preferably in the range of 15 to 45%, and more preferably 20-40%, of the total weight of the composition.

The composition according to the present invention is prepared by heating, preferably under stirring, suitable quantities of tetrabromobisphenol A together with the first, non-halogenated polyol liquid and the second, halogenated polyol liquid until a clear solution is obtained, following which the liquid composition is cooled and stored until use.

More preferably, the composition according to the present invention is prepared by introducing into a suitable vessel the first and second liquids, heating the mixture to a first temperature in the range between 50 and 60° C., adding tetrabromobisphenol A into said vessel, preferably under stirring, and heating the resulting mixture to a second temperature in the range between 80 and 100° C. A clear solution is generally obtained following a heating period of about 60 to 120 minutes at said second temperature. The mixture is then cooled to give the liquid flame retardant composition of the present invention in the form of a clear, stable solution.

As used herein, the term “liquid composition”, refers to the fact that the precipitation/crystallization of tetrabromobisphenol A from the liquid phase is substantially prevented. Namely, the liquid composition is essentially homogeneous, such that the formation of a separate phase containing tetrabromobisphenol A is substantially prevented. The term “substantially prevented” in this context is used to indicate that the liquid composition may exist either in the form of a clear, stable solution or as a composition in which a second phase (e.g. a precipitate) is formed, wherein said second phase contains tetrabromobisphenol A in an amount which does not exceed 5% of the total weight of said tetrabromobisphenol A in the composition.

Most preferably, the liquid composition is in the form of a solution. The liquid composition is capable of retaining the form of a stable solution at ambient temperature for not less than 50 days, and more preferably for not less than 70 days. For the purpose of this specification, ambient temperature is from 20 to 25° C. According to another embodiment, the liquid composition is capable of retaining the form of a stable solution at −18° C. for at least three days. The aforementioned stability tests may be performed by producing the liquid flame retardant according to the relevant composition, storing the same under the relevant conditions and following the waiting period(s) specified above, observing the composition to determine the presence or absence of a precipitate therein.

It should be noted that the liquid composition may contain additional ingredients that are generally useful for the contemplated application of the flame retardant composition, namely, for the preparation of rigid polyurethane foams. For example, one possible additive is a liquid ester of a pentavalent acid of phosphorus, such as an organic phosphate and/or an organic phosphonate ester, which is preferably an alkyl phosphate ester, a chloroalkyl phosphate ester or an alkyl alkane phosphonate ester, or a mixture of any two or more of these. The weight concentration of said liquid ester of a pentavalent acid of phosphorus is preferably in the range of 10 to 40% of the total weight of the composition. Particularly preferred additives belonging to this class are triester-trialkyl phosphates, such as tri(monochloroalkyl) phosphate or tri(dichloroalkyl) phosphate, with tris(2-chloropropyl)phosphate (abbreviated TCPP) being especially preferred. The term “alkyl” preferably refers to C₁-C₅ alkyl. It should be noted that the phosphate ester may be either symmetric or un-symmetric, containing identical or different alkyl groups, respectively.

Another additive that may be suitably included within the composition of the invention is an antioxidant, preferably at a concentration of up to 2000 ppm, which is used for stabilizing the polyols present in the composition. Most preferred is a phenolic antioxidant, which may be selected from the group consisting of 2,6-di-tert-butyl-p-cresol, 4,4′-methylenebis(2,6-di-tert-butylphenol), 2,2′-methylenebis(4,6-di-tert-butylphenol) and octadecyl 3,5-di-tert-butyl-4-hydroxyhydrocinnamate, and mixtures thereof.

Preferably, the composition provided by the present invention has halogen content between 25 and 35% (weight percent of the total weight of the composition), OH number between 100-350 mg KOH/g, and a viscosity at 25° C. of 5000-70000 cP. Preferred compositions provided by the present invention comprise tetrabromobisphenol A in a weight concentration in the range between 30 to 40% and—as the non-halogented polyol liquid—a non-viscous glycerol-based polyether-polyol in a weight concentration in the range between 10 to 40% (of the total weight of the composition). An especially preferred flame retardant of the present invention has the following composition:

### A) 30-40 wt % of tetrabromobisphenol-A

### B) 20-40 wt % of a glycerol-based polyether-polyol (e.g., Alcupol C-5710);

### C) 30-40 wt % of halogenated polyether-polyol containing aliphatic bromine (Ixol B 350) or halogenated polyol containing aromatic bromine (VD-400)

### D) 15-25 wt % of tris(2-chloropropyl)phosphate;

### E) Optionally up to 2000 ppm (wt/wt) of at least one phenolic antioxidant.

The amount of the liquid composition provided by the present invention, which is necessary for conferring commercially satisfactory flame retardancy to a particular polymer or polymer-containing composition may vary over a wide range. Usually, the flame retardant material of the present invention is employed in an amount of between about 1 to 50% by weight of the polymer, and preferably between about 3 to about 30%. In general, any suitably known method of incorporating flame retardants to polymer materials may be employed.

The novel composition of the present invention is particularly useful as a flame retardant for polyurethane and polyisocyanurate foams. As explained hereinabove, the liquid flame retardant provided by the present invention contains tetrabromobisphenol A as a solute, and may therefore be directly added to the liquid mixture of reactants used for preparing polyurethane and polyisocyanurate foams, whereby the blending operation of said mixture is considerably simplified and a uniform distribution of the components to be reacted is readily obtained in said mixture. In addition, the non-halogenated polyols included in the liquid flame retardant composition provided by the present invention are characterized by relatively high hydroxyl values and hydroxyl functionalities (the hydroxyl functionality of the composition is preferably not less than 3), which two characteristics are considered beneficial in the production of rigid polyurethanes and polyisocyanurate foams, allowing the formation of a highly cross-linked homogeneous glassy network structure of said foams, whereby good heat stability, high compression strength at low density and good barrier properties are achieved.

The new flame retardant compositions may be used in standard formulations for rigid polyurethane foams produced by continuous, discontinuous or spray methods, as well as for polyisocyanurate foams. Thus, the present invention also relates to a process which comprises:

providing a preformed flame retardant composition containing tetrabromobisphenol A dissolved in a mixture comprising one or more non-halogenated polyols and one or more halogenated polyols, wherein the weight ratio between said tetrabromobisphenol A and the total weight of said one or more non-halogenated polyols in said flame retardant composition is not less than 2:3; and
mixing said flame retardant composition with additional quantities of one or more polyols, and optionally with a blowing agent and a catalyst, thereby affording a polyol component suitable for the preparation polyurethane or polyisocyanate foams.

By the term “polyol component” is meant the total quantity of polyols that needs to be reacted in order to afford the foam. The resulting polyol component is subsequently reacted with an isocyanate component in the presence of a blowing agent and a catalyst, to obtain the polyurethane or polyisocyanate foam.

The flame-retardant composition which contains tetrabromobisphenol A dissolved in at least one non-halogenated polyol and at least one brominated polyol is used in a sufficient amount in order to allow the final foam to satisfy the requirements of the DIN 4102 B2 test. The bromine content of the final foam is typically not less than 1%. The amount of the flame-retardant composition is adjusted such that the bromine content of the final foam is in the range of 1-15%, and preferably in the range of 2-10%, and most preferably in the range of 2-5%, relative to the total weight of the foam.

If desired, the process according to the present invention for preparing the polyol component may be conveniently carried out on-site. The preformed flame-retardant composition containing tetrabromobisphenol A, as provided by the present invention, may be mixed on-site with one or more polyols (such as the polyether-polyols and polyester-polyols listed above), to give the polyol component of the foam, followed by the addition of a blowing agent and a catalyst, and possibly a surfactant, to said polyol component. The fact that the mixing step may be carried out on-site at the environmental temperature at the working site, whereby a polyol component containing the flame retardant homogeneously distributed therein is rapidly and easily obtained, constitutes an important advantage of the present invention.

Suitable blowing agents to be used according to the present invention include, for example, water (which produces carbon dioxide upon reaction with isocyanate) and low-boiling organic liquids, such as pentane or halogenated hydrocarbons (e.g., methylene chloride). The amount of the blowing agent may vary within a broad range.

As a reaction catalyst, intended for accelerating the reaction between the polyol component and the polyisocyanate component, it is common to use aromatic and/or aliphtatic amines, or organic metal salts, or a mixtures thereof. Amine catalysts may be selected from the group consisting of triethylenediamine, dimethylethanolamine (DMEA), tetramethylbutanediamine (TMBDA), dimethylcyclohexylamine (DMCHA), triethylamine (TEA). Organometallic salts are preferably based on the following metals: tin, zinc, manganese, magnesium, bismuth, antimony, lead and calcium. Particularly preferred are stannous compounds such as stannous octoate and stannous dibutyltindilaurate. Preferably, the weight concentration of the catalyst, relative to polyol component, is in the range between 1 and 5% (wt).

A surfactant may also be used in a small amount, up to 2% of the weight of polyol component in the preparation of the polyurethane foam. To this end silicones may be used.

Having formed the polyol component, which contains the aforementioned catalyst, blowing agent and surfactant dissolved therein, said polyol component is reacted with the isocyanate component to give the desired foam. Suitable isocyanates to be used according to the present invention may be selected from the group consisting of aliphatic, cycloaliphatic, araliphatic, aromatic or heterocyclic polyisocyanates, such as 4,4′-diphenylmethane diisocyanate, toluylene diisocyanate, isopropyl diisocyanate, hexamethylene diisocyanate. The amount of the polyisocyanate that is required for producing the foam is calculated according to the hydroxyl number of the polyol component, and it is also possible to use the polyisocyanate in a slight excess.

The rigid polyurethane foams may be prepared by either continuous, discontinuous or spray methods, which are well known in the art.

In a discontinuous process, all the components are mixed and poured into a mould, normally made of wood or metal, to form the foam. Following a suitable period of time, which depends on the system and size of the mould, the foam is removed from the mould as a block. The block is cured and then is cut into panels, half shells or other shapes.

In a continuous process, the reaction mixture is dispersed from a traversing head onto a conveyor, which is covered with a paper in order to facilitate release of the foam. During the expansion of the foam, the sides are supported by vertical conveyors. At the end of the foaming line, the foam is cut into buns and stored for a specified time. Later, the foam can be cut into the required shape.

Spray techniques are used for filling molds and panels and for applying foam to plane surfaces. Spraying is particularly useful in applications where large areas are involved, such as tanks or building walls. Sprayed rigid foam coatings provide both physical strength and improved insulation.

The following preparative examples illustrate preferred embodiments of the invention.

### EXAMPLES

### Example 1

A 0.5 liter reactor, equipped with a mechanical stirrer, a thermometer and a reflux condenser, was charged with 70 g of a reactive bromine-containing liquid polyol with a hydroxyl value of ˜400 KOH/g and a bromine content of ˜24% (w/w) (VD-400, Resina), and 60 g non-halogenated polyol (Alcupol C-5710), and the mixture was heated to 60° C. 70 g TBBA was then added portionwise and the temperature was increased to 100° C. The resulting mixture was heated for 2 hours at 100° C., until a clear solution was obtained. After cooling to room temperature, a stable solution with a viscosity of about 37,000 cP at 25° C. was obtained. The hydroxyl value of the blend was ˜311 mg KOH/g, the hydroxyl functionality was ˜3.2 and the bromine content was ˜29%.

### Example 2

A 0.5 liter reactor, equipped with a mechanical stirrer, a thermometer and a reflux condenser, was charged with 60 g of Halogenated polyether-polyol (Ixol B 350), and 80 g non-halogenated polyol (Alcupol C-5710) and the mixture was heated to 60° C. 60 g TBBA was then added portionwise and the temperature was increased to 100° C. The resulting mixture was heated for 2 hours at 100° C., until a clear solution was obtained. After cooling to room temperature, a stable solution with a viscosity of about 23,600 cP at 25° C. was obtained. The hydroxyl value of the blend was ˜333 mg KOH/g, the hydroxyl functionality was ˜3.0 and the bromine content was ˜27%.

### Example 3

A 0.5 liter reactor, equipped with a mechanical stirrer, a thermometer and a reflux condenser, was charged with 60 g of a reactive bromine-containing liquid polyol with a hydroxyl value of ˜400 KOH/g and a bromine content of ˜24% (w/w/)(VD-400S, Resina), 40 g non-halogenated polyol (Alcupol C-5710), and 40 g TCPP, and the mixture was heated to 60° C. 60 g TBBA was then added portionwise and the temperature was increased to 100° C. The resulting mixture was heated for 2 hours at 100° C., until a clear solution was obtained. After cooling to room temperature, a stable solution was obtained. The hydroxyl value of the blend was 234 mg KOH/g, the hydroxyl functionality was ˜3.2 and the bromine content was ˜25%.

### Examples 4-9

Six additional flame retardant compositions of this invention were prepared by the procedures as described in Examples 1-3, and used together with the compositions prepared in Examples 1-3 for storage stability tests and for foam preparation. Table 1 summarizes the compositions of all nine liquid flame retardants prepared, and the results of the stability tests carried in respect thereto. It should be noted that the stability tests are ongoing tests, and hence the values given in Table 1 indicate the number of days during which the compositions have been stored under room temperature conditions without observing the formation of a precipitate. The tests are continuing and thus the values given are not the limits of the stability.

TABLE 1
The results of stability tests of different flame
retardant compositions

| | | VD- | Ixol | | | | |
|---|---|---|---|---|---|---|---|
| | TBBA, | 400S, | B350, | C5710, | TCPP, | Viscosity | Stability, |
| Ex. | wt % | wt % | wt % | wt % | wt % | cP | days |
| 1 | 35 | 35 | | 30 | | 37,000 | ~400 |
| 2 | 30 | | 30 | 40 | | 23,600 | ~400 |
| 3 | 30 | 30 | | 20 | 20 | ND | ~400 |
| 4 | 40 | 30 | | 30 | | 38,300 | ~400 |
| 5 | 30 | 40 | | 30 | | 39,000 | ~400 |
| 6 | 30 | | 40 | 30 | | 42,200 | ~400 |
| 7 | 35 | | 35 | 30 | | ND | ~400 |
| 8 | 35 | | 30 | 35 | | ND | ~400 |
| 9 | 30 | | 30 | 20 | 20 | ND | ~400 |

*ND = not determined

The liquid compositions of the present invention were used as flame retardants in rigid polyurethane foams. The foams were prepared using formulations suitable for either continuous or discontinuous processes (Examples 10-18 and Example 19 below, respectively).

In addition to the flame retardant of the present invention, the following components were used in the preparation of the foams:

### Polyols Components Used for Continuous Production:

### 1. Terol 516—Polyester polyols having a hydroxyl value of 305 mg KOH/g.

### 2. Fox-O-Pol M530—a polyol having a hydroxyl value of 305 mg KOH/g.

### 3. Glycerol.

### Polyol Components Used for Discontinuous Production:

### 1. Alcupol R-2510—Glycerol initiated polyether-polyols having a hydroxyl value of 570 mg KOH/g.

### 2. Alcupol C-5710—Glycerol initiated polyether-polyols having a hydroxyl value of 250 mg KOH/g.

### 3. Alcupol R-4720—Sorbitol initiated polyether-polyols having a hydroxyl value of 475 mg KOH/g.

### Ancillary Chemicals

| | |
|---|---|
| DMCHA | dimethylcyclohexylamine |
| AM 58 | trimerisation catalyst |
| DC 193 | silicone surfactant |
| TCPP | tris (chloropropyl) phosphate |
| TEP | triethylenephosphate |
| Ixol B350 | Solvay, flame retardant |
| FOX-O-POL VD 280S | Resina Chemie |
| FOX-O-POL VD 400S | Resina Chemie |
| Pentane | blowing agent |

### Isocyanate

### MDI: polymeric diphenylmethane diisocyanate

### Examples 10-18

### Continuous Process for Preparing Rigid Polyurethane Foams Using the Liquid Flame Retardant Compositions

The procedure for the foam preparation was as follows:

The polyols, water, surfactant, flame retardant (abbreviated “FR” in the tables below) and catalysts were weighed and placed in a mixing beaker and mixed to form a homogeneous solution. To this solution was added pentane, and after additional mixing, the polymeric isocyanate. The mixture was stirred at 3000 rpm for 6 sec and poured into another beaker. The foam that formed was kept at least 24 hr at room temperature and then removed from the beaker and cut into test specimens with a saw. The samples were then tested for flammability according to the DIN 4102 B2 test procedure (a flame height of 15.0 cm or less means that the foam has passed the test), dimensional stability according to the DIN 53420 M-1 test procedure and density according to the DIN 53420 M-6 test procedure. Tables 2, 3, and 4 summarize the ingredients and parameters for the foam preparation and the results of the tests carried out in respect thereto.

TABLE 2
Pentane blown B2 continuous system using
compositions based on TBBA, VD-400 and Polyol
Alcupol C-5710 (hand mixed at 20° C.)

| Composition, g | Ex. 10 | Ex. 11 | Ex. 12 |
|---|---|---|---|
| M530 | 30 | 30 | 30 |
| Terol 516 | 30 | 30 | 30 |
| Glycerol | 5 | 5 | 5 |
| FR of Example 1 | 37.2 | | |
| TBBA/VD-400/C5710, 35:35:30 | | | |
| FR of Example 5 | | 37.2 | |
| TBBA/VD-400/C5710, 30:40:30 | | | |
| FR of Example 4 | | | 37.2 |
| TBBA/VD-400/C5710, 40:30:30 | | | |
| TCPP | 20 | 20 | 20 |
| TEP | 2.8 | 2.8 | 2.8 |
| DMCHA | 2 | 2 | 2 |
| AM58 | 1 | 1 | 1 |
| DC193 | 1.5 | 1.5 | 1.5 |
| Water | 2.49 | 2.49 | 2.49 |
| Pentane | 13.2 | 13.2 | 13.2 |
| Total | 145.19 | 145.19 | 145.19 |
| Isocyanate, g (Urestyl-10) | 171.09 | 173.08 | 169.11 |
| Mix time, sec | 6 | 6 | 6 |
| Cream time, sec | 11.5 | 10.5 | 10.5 |
| Gel time, sec | 47 | 44 | 33 |
| Tack free time, sec | 48 | 44 | 39 |
| Cure time, sec | | | 111 |
| Br content in polyol | 8.2 | 7.8 | 8.7 |
| mixture, wt % | | | |
| Br content in foam, wt % | 3.6 | 3.4 | 3.9 |
| Density, kg/m³ | 26.9 | 27.6 | 26.8 |
| Dimensional stability, %, | 1.8 | 0.8 | 1.3 |
| 100° C./24 h | | | |
| Flame height, cm (DIN 4102) | 11.4 | 11.8 | 11.1 |

In table 2 (and also in the tables to follow) the parameters related to the foam preparation are defined as follows:

Cream time: The time between the discharge of the foam ingredients from the mixing beaker and the beginning of the rise of the foam.
Gel time: The time between the discharge of the foam ingredients from the mixing beaker and the time that the foam will stick to an introduced probe, and strings out from it when withdrawn.
Tack-free time: The time between the discharge of the foam ingredients from the mixing beaker and the time that the outer skin of the foam mass loses its stickiness or adhesive quality.
Cure time: The time required for sufficient reaction completion to develop the desired polymer properties such as strength, dimensional stability, elongation, etc.

TABLE 3
Pentane blown B2 continuous system using
compositions based on TBBA, Ixol B350 and Polyol C 5710
(hand mixed at 20° C.)

| Composition, g | Ex. 13 | Ex. 14 | Ex. 15 | Ex. 16 |
|---|---|---|---|---|
| M530 | 30 | 30 | 30 | 30 |
| Terol 516 | 30 | 30 | 30 | 30 |
| Glycerol | 5 | 5 | 5 | 5 |
| FR of Example 2 | 37.2 | | | |
| TBBA/Ixol B350/C5710, | | | | |
| 30:30:40 | | | | |
| FR of Example 6 | | 37.2 | | |
| TBBA/Ixol B350/C5710, | | | | |
| 30:40:30 | | | | |
| FR of Example 7 | | | 37.2 | |
| TBBA/Ixol B350/C5710, | | | | |
| 35:35:30 | | | | |
| FR of Example 8 | | | | 37.2 |
| TBBA/Ixol B350/C5710, | | | | |
| 35:30:35 | | | | |
| TCPP | 20 | 20 | 20 | 20 |
| TEP | 2.8 | 2.8 | 2.8 | 2.8 |
| DMCHA | 2 | 2 | 2 | 2 |
| AN58 | 1 | 1 | 1 | 1 |
| DC193 | 1.5 | 1.5 | 1.5 | 1.5 |
| Water | 2.49 | 2.49 | 2.49 | 2.49 |
| Pentane | 13.2 | 13.2 | 13.2 | 13.2 |
| Total | 145.19 | 145.19 | 145.19 | 145.19 |
| Isocyanate, g (Urestyl-10) | 173.22 | 171.04 | 169.3 | 170.4 |
| Mix time, sec | 6 | 6 | 6 | 6 |
| Cream time, sec | 10 | 11 | 13.5 | 12.5 |
| Gel time, sec | 31 | 31 | 20–29 | 38 |
| Tack free time, sec | 35.5 | 36.5 | 37–46 | 44 |
| Cure time, sec | 110 | 110–160 | 120–140 | 145 |
| Br content in polyol | 7.6 | 8.5 | 8.9 | 8.5 |
| mixture, wt % | | | | |
| Br content in foam, wt % | 3.3 | 3.7 | 3.9 | 3.7 |
| Density, kg/m³ | 27.1 | 27.3 | 26.6 | 27.2 |
| Dimensional stability, | 1.5 | 0.8 | 1.2 | 0.9 |
| 100° C./24 h | | | | |
| Flame height, cm (DIN | 11.8 | 11.5 | 11.1 | 10.9 |
| 4102) | | | | |

TABLE 4
Pentane blown B2 continuous system using
compositions based on TBBA, VD-400 or Ixol, TCPP, and
Polyol C5710 (hand mixed at 20° C.)

| composition, g | Ex. 17 | Ex. 18 |
|---|---|---|
| M530 | 30 | 30 |
| Terol 516 | 30 | 30 |
| Glycerol | 5 | 5 |
| FR of Example 9 | 37.2 | |
| TBBA/IxolB350/TCPP/C5710, | | |
| 30:30:20:20 | | |
| FR of Example 3 | | 37.2 |
| TBBA/VD400/TCPP/ | | |
| C5710, 30:30:20:20 | | |
| TCPP | 20 | 20 |
| TEP | 2.8 | 2.8 |
| DMCHA | 2 | 2 |
| AM58 | 1 | 1 |
| DC193 | 1.5 | 1.5 |
| Water | 2.49 | 2.49 |
| Pentane | 13.2 | 13.2 |
| Total | 145.19 | 145.19 |
| Isocyanate, g (Urestyl-10) | 161.59 | 163.13 |
| Mix time, sec | 6 | 6 |
| Cream time, sec | 11 | 15 |
| Gel time, sec | 30 | 45 |
| Tack free time, sec | 39 | 60 |
| Cure time, sec | 101 | 121 |
| Br content in polyol | 7.6 | 7.0 |
| mixture, wt % | | |
| Br content in foam, wt % | 3.5 | 3.2 |
| Density, kg/m³ | 27.4 | 27.3 |
| Dimensional stability, | 1.1 | 0.5 |
| 100° C./24 h | | |
| Flame height, cm | 10.5 | 10.8 |
| (DIN 4102) | | |

### Example 19

In this example, a standard, rigid polyurethane foam was prepared in the water-blown discontinuous system to pass DIN 4102 part 1, Class B2, using the flame retardant composition of Example 8.

The procedure for the foam preparation was as follows:

The polyols, water, surfactant, flame retardant and catalysts were weighed and placed in a mixing beaker, and mixed to form a homogeneous solution. To this solution was added the polymeric isocyanate, then the mixture was stirred at 3000 rpm for 15 sec and poured into another beaker. The foam that formed was kept at least 24 hr at room temperature and then removed from the beaker and cut into test specimens with a saw. The samples were then tested for flammability according to the DIN 4102 B2 test procedure (a flame height of 15.0 cm or less means that the foam has passed the test), dimensional stability according to the DIN 53420 M-1 test procedure and density according to the DIN 53420 M-6 test procedure. Table 5 summarizes the ingredients and parameters for the foam preparation and the results of the testing of the foam.

TABLE 5
Water blown B2 discontinuous system using
compositions based on TBBA, Ixol B350 and Polyol Alcupol
C-5710 (hand mixed at 20° C.)

| Composition, g | Ex. 19 |
|---|---|
| R4720 | 35 |
| R2510 | 23 |
| C5710 | 24 |
| FR of Example 8 | 20 |
| TBBA/IxolB35o/C5710, | |
| 35:30:35 | |
| TCPP | 25 |
| DMCHA | 0.9 |
| DC 193 | 1.5 |
| Water | 4.6 |
| Total | 134 |
| Isocyanate, g (Urestyl-10) | 172.3 |
| Mix time, sec | 15 |
| Cream time, sec | 30 |
| Gel time, sec | 154 |
| Tack free time, sec | 288 |
| Density, kg/m³ | 33.5 |
| Flame height, cm (DIN 4102) | 13.9 |

It can be seen that all the tested foam samples based on the new flame retardant compositions had good properties, provided a high level of fire retardant efficiency to the rigid polyurethane foams, and met the German DIN 4102 B2 fire safety standard.

### Example 20 (Comparative)

An attempt to dissolve 35% tetrabromobisphenol A in Ixol 350 or in VD-400 (w/w) was unsuccessful, resulting in the precipitation of tetrabromobisphenol from the liquid phase upon cooling the composition to room temperature.

1) A flame retardant composition which comprises a first liquid, which is selected from the group consisting of non-halogenated polyols and mixtures thereof; a second liquid, which is selected from the group consisting of halogenated polyols or mixtures thereof; and tetrabromobisphenol A.

2) A flame retardant composition according to claim 1, wherein the weight ratio between tetrabromobisphenol A and the first liquid is not less than 2:3.

3) A flame retardant composition according to claim 1, which is in the form of a solution at ambient temperature.

4) A flame retardant composition according to claim 1, wherein the bromine content of the composition is not less than 24% (w/w).

5) A flame retardant composition according to claim 1, wherein the first liquid comprises at least one non-halogenated polyol that contains not less than 3 hydroxyl groups.

6) A flame retardant composition according to claim 1, wherein the non-halogenated polyol is a polyether-polyol.

7) A flame retardant composition according to claim 1, wherein the halogenated polyol is halogenated polyether polyol having aliphatic bromine.

8) A flame retardant composition according to claim 1, wherein the halogenated polyol comprises aromatic bromine.

9) A flame retardant composition according to claim 6, wherein the weight percent of tetrabromobisphenol A is in the range between 30 and 40% and the weight percent of the non-halogenated polyether-polyol is in the range between 10 to 40% of the total weight of the composition.

10) A flame retardant composition according to claim 9, which comprises:
A) 30-40 wt % of tetrabromobisphenol-A
B) 20-40 wt % of a glycerol-based polyether polyol;
C) 30-40 wt % of halogenated polyether polyol containing aliphatic bromine;
D) 15-25 wt % of tris(2-chloropropyl)phosphate;
E) Optionally up to 2000 ppm (wt/wt) of at least one phenolic antioxidant.

11) A flame retardant composition according to claim 9, which comprises:
A) 30-40 wt % of tetrabromobisphenol-A
B) 20-40 wt % of a glycerol-based polyether polyol;
C) 30-40 wt % of halogenated polyol containing aromatic bromine;
D) 15-25 wt % of tris(2-chloropropyl)phosphate;
E) Optionally up to 2000 ppm (wt/wt) of at least one phenolic antioxidant.

12) A process for preparing a liquid composition containing tetrabromobisphenol A dissolved therein, which comprises heating tetrabromobisphenol A together with a first liquid, which is a non-halogenated polyol, and a second liquid, which is halogenated polyol, until a clear solution is obtained, and cooling the resulting solution.

13) A process according to claim 12, wherein the weight ratio between said tetrabromobisphenol A and the first liquid is not less than 2:3.

14) A process according to claim 13, which comprises introducing into a suitable vessel the first and second liquids, heating the mixture to a first temperature in the range between 50 and 60° C., adding tetrabromobisphenol A into said vessel and heating the resulting mixture to a second temperature in the range between 80 and 100° C., to obtain a clear solution and cooling said solution.

15) A process, which comprises: providing a flame retardant composition containing tetrabromobisphenol A dissolved in a mixture comprising one or more non-halogenated polyols and one or more halogenated polyols, wherein the weight ratio between said tetrabromobisphenol A and the total weight of said one or more non-halogenated polyols in said flame retardant composition is not less than 2:3; and
mixing said flame retardant composition with additional quantities of one or more polyols, and optionally with a blowing agent and a catalyst, thereby affording a polyol component suitable for the preparation polyurethane or polyisocyanate foams.

16) A process according to claim 15, which further comprises reacting the polyol component with an isocyanate component in the presence of a blowing agent and a catalyst, to obtain a polyurethane or polyisocyanate foam.

17) A process according to claim 15, which is carried out on-site at the environmental temperature at the working site.

18) A process according to claim 15, wherein the weight percent of tetrabromobisphenol A in the flame retardant composition is in the range between 30 and 40% and the weight percent of the one or more non-halogenated polyol is in the range between 10 to 40% of the total weight of the flame retardant composition.

19) A process according to claim 18, wherein the flame retardant composition is a solution which comprises:
A) 30-40 wt % of tetrabromobisphenol-A
B) 20-40 wt % of a glycerol-based polyether polyol;
C) 30-40 wt % of halogenated polyether polyol containing aliphatic bromine or 30-40 wt % of halogenated polyol containing aromatic bromine;
D) 15-25 wt % of tris(2-chloropropyl)phosphate;
E) Optionally up to 2000 ppm (wt/wt) of at least one phenolic antioxidant.
